(19) United States
(12) Patent Application Publication
(10) Pub. No.: US 2013/0046575 A1
(43) Pub. Date: Feb. 21, 2013

(54) Broadcast display guide

(71) Applicant: James Michael O'Neill, Chicago, IL (US)

(72) Inventor: James Michael O'Neill, Chicago, IL (US)

(21) Appl. No.: 13/165,451

(22) Filed: Aug. 19, 2011

(51) Int. Cl. G06Q 30/00; B42D 15/00; G06Q 10/00

(52) U.S. Cl. 705/7.29; 705/14.4; 283/115

(57) ABSTRACT

Embodiments of the invention relate to methods for collecting, providing and displaying information related to at least one broadcast. The method comprises collecting information about a plurality of broadcast providers and collecting information about at least one broadcast station provided by each of the broadcast providers. The method further comprises collecting information about advertising related to the broadcast.

### FIELD OF THE INVENTION

The invention relates to broadcasts. More specifically, embodiments relate to a method of collecting, providing and displaying information related to a broadcast.

### BACKGROUND OF THE INVENTION

Before cable, satellite and digital television providers became available, viewers knew what channel number corresponded to their favorite sports team broadcast. Nowadays, if a fan has one provider at home, he knows what channels his teams are broadcast on. However, if the same fan is at a tavern/restaurant, hotel, stuck in an airport bar, or at a friend's home for example, and that location has a different provider, the fan has no idea what channel number his teams are broadcast on. He can ask the bartender to change to the game, but if the bartender doesn't know the channel, the owner/manager of the establishment is busy, or the guide list is five years old (the channel numbers have changed), getting to watch and enjoy the game can become quite annoying.

There is a need to provide broadcast information to the viewing public in a simple format. There is a further need to keep costs down, by incorporating advertising and/or sponsor information in such information.

### SUMMARY OF THE INVENTION

One embodiment relates to a method for collecting information related to a broadcast. The method comprises collecting information about a plurality of broadcast providers; collecting information about at least one broadcast station provided by each of the broadcast providers and collecting information about advertising related to the broadcast.

Yet another embodiment relates to a method for providing information related to a broadcast, the method comprises collecting information about a plurality of broadcast providers and collecting information about at least one broadcast station provided by each of the broadcast providers. The method further comprises collecting information about advertising related to the broadcast and displaying the information about the plurality of broadcast providers, the broadcast station and advertising.

Still one other embodiment relates to a method of displaying information related to at least one broadcast, the method comprising displaying information about a plurality of broadcast providers in a first direction and displaying information about at least one broadcast station provided by each of the broadcast providers in a second direction different from the first direction. The embodiment further comprises displaying information about advertising related to the broadcast.

One more embodiment relates to a guide comprising two sides. The first side displays information about a plurality of broadcast providers in a first direction and information about at least one broadcast station provided by each of the broadcast providers in a second direction different from the first direction. The second side displays information about advertising related to the broadcast.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents.

### BRIEF DESCRIPTION OF THE DRAWINGS

FIG. 1 depicts a schematic representation of a method of displaying broadcast information in accordance with one embodiment of the present invention.

Throughout the various FIGURE, like reference numbers refer to like elements.

### DETAILED DESCRIPTION OF PRESENTLY PREFERRED EMBODIMENTS

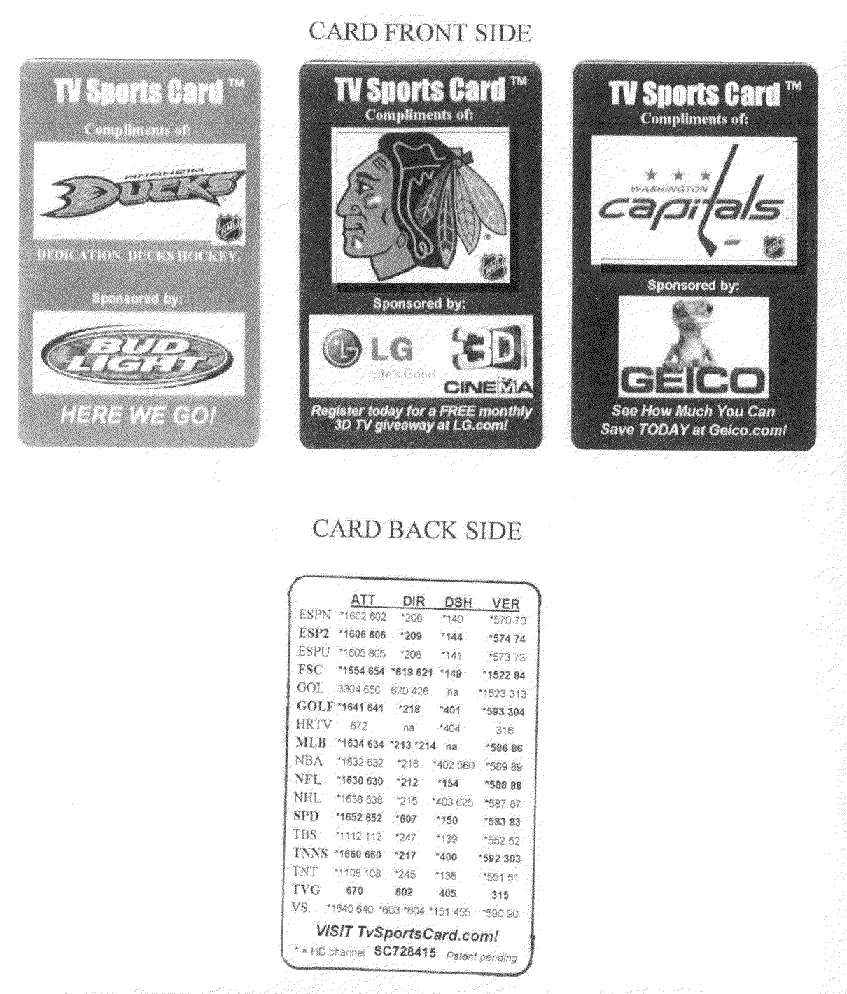

FIG. 1 depicts a schematic representation of a method of displaying broadcast information in accordance with one embodiment of the present invention. More specifically, FIG. 1 depicts a card or guide having broadcast provider information (i.e., channel numbers) on one side and advertising or sponsorship information on another side. Alternatively, the card or guide may comprise two separate cards joined or connected together in a foldable or bendable fashion similar to a wallet or all the information displayed on one side.

One embodiment relates to a method for collecting information related to a broadcast. The method comprises collecting information about a plurality of broadcast providers; collecting information about at least one broadcast station provided by each of the broadcast providers and collecting information about advertising related to the broadcast.

Yet another embodiment relates to a method for providing information related to a broadcast, the method comprises collecting information about a plurality of broadcast providers and collecting information about at least one broadcast station provided by each of the broadcast providers. The method further comprises collecting information about advertising related to the broadcast and displaying the information about the plurality of broadcast providers, the broadcast station and advertising

Still one other embodiment relates to a method of displaying information related to at least one broadcast, the method comprising displaying information about a plurality of broadcast providers in a first direction and displaying information about at least one broadcast station provided by each of the broadcast providers in a second direction different from the first direction. The embodiment further comprises displaying information about advertising related to the broadcast.

One more embodiment relates to a guide comprising two sides. The first side displays information about a plurality of broadcast providers in a first direction and information about at least one broadcast station provided by each of the broadcast providers in a second direction different from the first direction. The second side displays information about advertising related to the broadcast.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof. While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for collecting information related to a broadcast, the method comprising:
collecting information about a plurality of broadcast providers;
collecting information about at least one broadcast station provided by each of the broadcast providers; and
collecting information about advertising related to the broadcast.

2. A method for providing information related to a broadcast, the method comprising:
collecting information about a plurality of broadcast providers;
collecting information about at least one broadcast station provided by each of the broadcast providers;
collecting information about advertising related to the broadcast; and
displaying the information about the plurality of broadcast providers, the broadcast station and advertising.

3. A method of displaying information related to at least one broadcast, the method comprising:
displaying information about a plurality of broadcast providers in a first direction;
displaying information about at least one broadcast station provided by each of the broadcast providers in a second direction different from the first direction; and
displaying information about advertising related to the broadcast.

4. A guide comprising:
A first side displaying information about a plurality of broadcast providers in a first direction and displaying information about at least one broadcast station provided by each of the broadcast providers in a second direction different from the first direction; and
a second side displaying information about advertising related to the broadcast.
